(19) United States
(12) Patent Application Publication
(10) Pub. No.: US 2007/0041067 A1
(43) Pub. Date: Feb. 22, 2007

(54) Document security strip and secured document

(75) Inventors: Werner Reinhart, Zirndorf (DE); Jean-Michel Grimal, Ceyrat (FR); Maurice Perron, Paris (FR)

Correspondence Address: HOFFMANN & BARON, LLP, 6900 JERICHO TURNPIKE, SYOSSET, NY, 11791, US

(73) Assignees: BANQUE DE FRANCE, Paris (FR); LEONHARD KURZ GMBH & CO. KG, Furth (DE)

(21) Appl. No.: 10/561,769

(22) PCT Filed: Jun. 23, 2004
(86) PCT No.: PCT/FR04/01564

§ 371 Date: Sep. 14, 2006

(30) Foreign Application Priority Data
Jun. 23, 2003 (FR) 03/07568

(51) Int. Cl. G02B 5/32

(52) U.S. Cl. 359/15

(57) ABSTRACT

The present invention concerns a strip for safeguarding a document, comprising a support on which there is formed in the longitudinal direction of the strip an alternation of generally metallised regions and generally transparent regions, said alternation being capable of establishing a contrast on a scale identified as global at the level of the document to be safeguarded in such a way as to constitute protection against reproduction of the documents with which the strip will be associated, characterised in that the strip also comprises optically active elements in association with the generally metallised regions and/or the generally transparent regions of the strip to produce an optical effect on a scale identified as detail at the level of the document to be safeguarded, said optical effect making it possible to constitute a recognisable sign for identifying said document. The present invention finally concerns a security document incorporating a strip as set forth hereinbefore.

The present invention concerns a strip for safeguarding a document, comprising a support on which there is formed in the longitudinal direction of the strip an alternation of generally metallised regions and generally transparent regions, said alternation being capable of establishing a contrast on a scale identified as global at the level of the document to be safeguarded in such a way as to constitute protection against reproduction of the documents with which the strip will be associated.

The invention also concerns security documents incorporating such a strip according to the invention.

Those documents can be for example fiduciary documents such as banknotes, or official documents, etc.

It is already known for strips as set forth in hereinbefore to be associated with security documents.

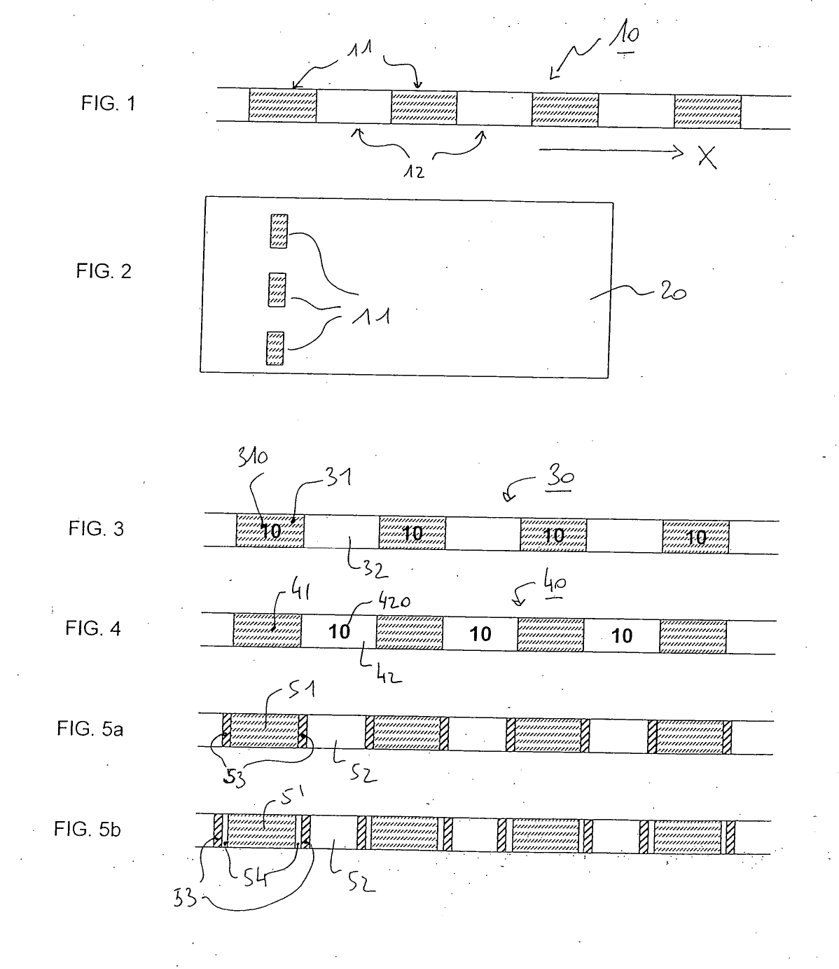

FIG. 1 thus shows a strip 10 of generally known type.

That strip 10 comprises a continuous longitudinal support, on which generally metallised regions 11 are formed.

The strip can be of a general multi-layer structure.

Those generally metallised regions are arranged in such a way as to provide between them generally transparent regions 12, in the longitudinal direction of the strip (indicated at X).

The arrangement of the regions 11 and 12 is implemented in such a way as to produce in the longitudinal direction of the strip an alternation of generally metallised regions 11 and generally transparent regions 12. The generally metallised regions 11 thus constitute discrete generally metallised elements.

Those regions can be for example smooth, purely reflective, metallised regions.

A strip of the known type of the strip 10 constitutes a security sign which can be associated with a document.

Such an association can for example involve transfer on to the document of the entire strip, with its support.

Such a transfer can be in particular a hot transfer.

In that case the support must be transparent (at least opposite the regions 12).

It is also possible to implement selective transfer of certain regions of the strip (for example the generally metallised regions 11).

Other procedures can also be used for associating the strip with the document to be safeguarded (stamping, etc . . . ).

FIG. 2 thus illustrates a document 20 such as a banknote, with which a strip of the type shown in FIG. 1 has been associated.

The generally metallised regions 11 of the strip are visible on the document and constitute a security mark.

It will be noted that the regions between the generally metallised regions 11, once the strip has been associated with the note, can be covered by a varnish or lacquer producing a visible effect for the naked eye. That varnish may correspond for example to a layer of the strip which is associated with the support of the strip.

A non-limiting example of such a safeguard strip will be found in EP 522 217.

Such safeguard strips thus constitute a security mark for the documents.

In particular each generally metallised region 11 forms a high degree of contrast with the generally transparent regions 12 which surround it, in the longitudinal direction of the strip.

Those regions are selected to be of a sufficiently large size for the contrast to correspond to a contrast on a scale identified as global at the level of the document to be safeguarded.

That contrast on a global scale (or ‘macro-contrast’) corresponds in particular to good protection against reproduction of the document with which the strip will be associated (for example by means of a photocopier).

An object of the invention is to make it possible to still further improve the level of security associated with document safeguard strips of the general type described hereinbefore.

Another object of the invention is to provide signs for the authentication of security documents which effectively complete the above-indicated arrangements in regard to protection against reproduction of the document.

In order to attain those objects, in accordance with a first aspect the invention proposes a strip for safeguarding a document, comprising a support on which there is formed in the longitudinal direction of the strip an alternation of generally metallised regions and generally transparent regions, said alternation being capable of establishing a contrast on a scale identified as global at the level of the document to be safeguarded in such a way as to constitute protection against reproduction of the documents with which the strip will be associated, characterised in that the strip also comprises optically active elements in association with the generally metallised regions and/or the generally transparent regions of the strip to produce an optical effect on a scale identified as detail at the level of the document to be safeguarded, said optical effect making it possible to constitute a recognisable sign for identifying said document.

Preferred but non-limiting aspects of such a strip are as follows:

said optical effect established on said detail scale is a contrast,

said optical effect established on said detail scale is a visual effect dependent on the angles of illumination and/or observation of the strip,

said generally transparent regions of the strip are associated with a varnish producing a glossy effect visible to the naked eye,

said optically active elements comprise optically active structures formed from a metallisation,

said optically active elements comprise optically variable elements,

at least some of said optically active structures comprise one or more of the following safeguard elements:
zone comprising diffraction lines,
purely reflective metallised zone,
zone comprising a diffraction mat,
zone comprising a hologram,
demetallised zone of a generally metallised region,
zone bearing printing, and
metallised zone of a generally transparent region,

at least some of said optically active structures comprise different zones of which some comprise at least one of said safeguard elements,

at least some of said zones are of a sufficiently small dimension as to not be immediately perceptible to the naked eye,

at least some of said optically active elements are associated with generally metallised regions,

said optically active elements comprise a diffraction mat integrated into a diffractive metallised region,

said optically active elements comprise purely reflective metallised regions,

said optically active elements comprise purely reflective metallised regions which, in the longitudinal direction of the strip, are disposed on respective sides of at least some of said generally metallised regions of the strip, said metallised regions being generally diffractive regions,

for each generally metallised and diffractive region, on respective sides of which are disposed purely reflective metallised regions, said purely reflective regions are disposed in immediately adjacent relationship with said generally metallised and diffractive region,

for each generally metallised and diffractive region, on respective sides of which are disposed purely reflective metallised regions, said purely reflective regions are disposed in such a way as to provide in the longitudinal direction of the strip an interval between said purely reflective region and said generally metallised and diffractive region,

said interval is transparent,

at least some of said optically active elements are associated with generally transparent regions,

said optically active elements comprise purely reflective metallised regions which, in the longitudinal direction of the strip, are disposed on respective sides of at least some of said generally transparent regions of the strip,

for each generally transparent region on respective sides of which are disposed purely reflective metallised regions, said purely reflective regions are disposed in immediately adjacent relationship with said generally transparent region,

for each generally transparent region on respective sides of which are disposed purely reflective metallised regions, said purely reflective regions are disposed in such a way as to provide in the longitudinal direction of the strip an interval between said purely reflective region and said generally transparent region,

said interval is:
an interval comprising metallised and diffractive zones, and/or
an interval comprising printed zones, and/or
an interval comprising a diffraction mat, and/or
an interval comprising a hologram,

said optically active elements are associated in register relationship with the generally metallised regions and/or the generally transparent regions of the strip,

the strip is also associated with luminescent or absorbent motifs,

said luminescent or absorbent motifs are printed in overlapping relationship with the strip,

said printing is effected in at least partially overlapping relationship with generally metallised regions of the strip,

said printing is effected in at least partially overlapping relationship with generally transparent regions of the strip, and

said luminescent or absorbent motifs are integrated in the interior of the strip.

In accordance with a second aspect the invention also proposes a security document incorporating a strip according to one of the above-mentioned aspects.

Other aspects will be more clearly apparent from the description hereinafter of the invention set out with reference to the accompanying drawing in which, besides FIGS. 1 and 2 which have already been discussed hereinbefore:

FIG. 3 is a diagrammatic view of a first embodiment of a document safeguard strip according to the invention,

FIG. 4 is a diagrammatic view of a second embodiment of a document safeguard strip according to the invention, and

FIGS. 5a and 5b are two diagrammatic views of two particular variants of the invention.

FIG. 3 diagrammatically shows a strip 30 for safeguarding a document, according to the invention.

That strip 30, like all the document safeguard strips according to the invention, involves the general features which have been discussed hereinbefore with reference to FIG. 1.

Thus this strip again comprises in the longitudinal direction of the strip an alternation (it should be made clear here that the notion of alternation implies recurrent repetition, in the meaning of the present text) of:

generally metallised regions 31, and

generally transparent regions 32.

In the case of the safeguard strips according to the invention as in the case of the strips of known type which have been described hereinbefore with reference to FIGS. 1 and 2 the strip can be associated with a document to be safeguarded by transfer, by stamping or by any other type of procedure.

It will be noted from FIG. 3 that the generally metallised regions 31 are associated with additional elements.

More precisely those additional elements are optically active elements 310.

It will be seen by reference to the other Figures that it is possible to associate different types of optically active elements with a safeguard strip according to the invention.

In all cases the optically active elements can be in the form of digits or characters.

More generally those optically active elements may correspond to any desired predetermined style of graphics.

In the case shown in FIG. 3 the optically active elements 310 appear in the form of digits (which digits for example may correspond to the denomination of a banknote).

The optically active elements 310 are capable of producing a given optical effect, in their combination with their background (in the case shown in FIG. 3, the generally metallised regions 31).

That optical effect may correspond to a contrast.

That optical effect may also correspond to a visual effect which is dependent on the angles of illumination and/or observation of the strip. That will be the case in particular when the optically active elements are made from diffractive and/or holographic motifs.

The generally transparent regions 32 which are interposed between the generally metallised regions 31 are preferably associated with a varnish producing a glossy effect which is visible to the naked eye.

It will be made clear that the generally metallised regions 31 and the generally transparent regions 32 can generally be of any desired geometry, even if they are shown in the form of rectangles in the Figures.

The geometry of the generally metallised regions of the strip however will generally involve characteristics in respect of sufficiently large size and in respect of compactness which permit them to effectively perform a function of affording protection against reproduction.

It will be noted that it will be possible to refer to EP 522 217 for a (non-limiting) example of the description of such conditions in respect of size and compactness.

Returning to the particular example of FIG. 3 the optically active elements 310 are therefore constituted in the interior of the generally metallised regions 31.

Those generally metallised regions 31 can be purely reflective metallised regions.

They can also involve regions comprising diffraction lines, a hologram or other means making it possible to modify the general appearance of the region 31.

At any event the optically active element 310 has optical properties which are distinguished from those of the generally metallised region 31 so as to produce an optical effect as discussed hereinbefore.

The optically active element 310 can be of a homogeneous structure.

It too may also be made from a metallisation.

The optically active elements 310 may also comprise optically variable elements.

The term ‘optically variable elements’ is used to denote elements whose optical properties can vary in dependence on the angle of illumination and/or observation. In particular this may thus involve diffractive and/or hologram structures.

The optical variable elements are therefore optically active elements of a particular type.

The optically active elements 310 may generally be formed by one of the following safeguard elements:

a zone comprising diffraction lines,

a purely reflective metallised zone,

a zone comprising a diffraction mat,

a zone comprising a hologram,

a demetallised zone of a generally metallised region, and

a zone carrying a print.

Those optically active elements 310 may also be produced in the form of structures comprising a plurality of safeguard elements as referred to hereinbefore.

Generally the optically active elements thus produce an optical effect on a scale less than the ‘global’ scale at which the contrast effect between the generally metallised regions 31 and the generally transparent regions 32 is produced.

That optical effect is produced on a scale which will be referred to as the detail scale. The optically active elements 310 thus produce optical effects which are localised in the strip 30.

They permit an observer to detect the presence of the optically active element, thus permitting identification and authentication of the document with which the strip is associated.

The optically active elements 310 shown in FIG. 3 are of a sufficiently large size for them to be easily observed with the naked eye.

It will be specified that it is also possible to produce such optically active elements of a sufficiently small dimension for them not to be immediately perceptible with the naked eye.

In that case, only attentive examination of the document can reveal the presence of those optically active elements and result in authentication of the document.

It will also be noted from FIG. 3 that the optically active elements 310 are associated in register relationship with the generally metallised regions 31 of the strip.

It will be specified here that the term ‘in register relationship’ is used to denote the characteristic whereby the optically active motifs 310 are systematically disposed in facing relationship with the generally metallised regions.

As will be seen it is also possible to associate such optically active elements with the generally transparent regions of the strip. In that case also that association may in particular be implemented in register relationship.

FIG. 3 thus shows a particular embodiment of the invention in which the optically active elements 310 are associated with generally metallised regions.

As stated above those optically active elements may be formed by or comprise a diffraction mat.

The term ‘diffraction mat’ is defined as being a zone diffracting the light in accordance with a single wavelength in all directions in space. Such a diffraction mat thus appears to an observer as being of the same appearance, irrespective of the angle of illumination and/or observation of the mat.

In accordance with a particular variant of the embodiment of FIG. 3 the optically active element 310 can thus be a diffraction mat, in a metallised region 31 which in particular can be generally diffractive.

The optically active elements 310 can also be formed by or comprise purely reflective metallised regions.

In a particular variant which corresponds to the diagrammatic view in FIG. 5a such optically active elements produced in the form of purely reflective metallised regions can be disposed, in the longitudinal direction of the strip, on respective sides of at least some generally metallised regions of the strip.

In this case also those generally metallised regions of the strip may be generally diffractive regions.

FIG. 5a thus shows:

an alternation of:
generally metallised regions 51 which in particular can be diffractive, and
generally transparent regions 52,

and zones 53 which correspond to optically active elements and which are in the form of purely reflective metallised regions.

In the variant illustrated in FIG. 5a the regions 53 are disposed in immediately adjacent relationship with the metallised region 51, on respective sides of which they are disposed.

In the variant illustrated in FIG. 5b it is also possible to provide that the zones 53 which correspond to the optically active elements are disposed in such a way as to provide in the longitudinal direction of the strip an interval between each purely reflective region 53 and the generally metallised region 51 with which it is associated.

FIG. 5b shows such intervals 54.

It will be noted that those intervals may for example be transparent.

FIG. 4 illustrates another embodiment of the invention.

It will be noted that all of the features which have been set forth hereinbefore in relation to:

generally metallised regions and generally transparent regions,

optically active elements, and

the association of the strip with a document to be safeguarded are applicable to this embodiment, just like to all the embodiments of the invention.

In the case of the strip 40 shown in FIG. 4 the optically active elements 420 are associated with generally transparent regions 42 of the strip.

The strip moreover comprises generally metallised regions 41.

Here too the optically active elements 420 can therefore assume various forms.

It will be noted that in this embodiment those optically active elements may also correspond to a metallised zone of a generally transparent region 42.

Here too the optically active elements can be in the form of purely reflective metallised zones.

In accordance with a variant it is here too possible to provide that the optically active elements are in the form of purely reflective zones disposed on respective sides of at least some transparent regions of the strip.

In this case also the optically active elements in the form of purely reflective zones can be disposed in immediately adjacent relationship with the generally transparent region with which they are associated.

In accordance with a variant which is not illustrated in the Figures it is possible here too to provide in the longitudinal direction an interval between each purely reflective region and the generally transparent region with which it is associated.

Such an interval may be in particular:

an interval comprising diffractive metallised zones, and/or

an interval comprising printed zones, and/or

an interval comprising a diffraction mat, and/or

an interval comprising a hologram.

In accordance with a variant of the invention it is also possible for luminescent or optically absorbent motifs to be associated with the safeguard strip.

In particular such motifs may be printed in overlapping relationship with the strip.

That printing operation can be carried out prior to the association of the strip with the document to be safeguarded, or afterwards.

That printing operation can be carried out in such a way as to:

cover (at least partially) only generally metallised regions of the strip,

cover (at least partially) only generally transparent regions of the strip, and

cover (at least partially) both generally metallised regions and generally transparent regions of the strip.

It is also possible for such luminescent or absorbent motifs to be integrated into the interior of the strip.

That can be effected for example by disposing a layer comprising such motifs in the thickness of the multi-layer structure of the strip.

The invention thus makes it possible to increase the level of security associated with the known strips as described with reference to FIGS. 1 and 2, in particular by permitting identification and authentication of the document with which the strip is associated.

It will be noted that the different embodiments and variants of the invention which have been set forth hereinbefore can be combined with each other.

In particular it is possible to provide optically active elements in association both with generally metallised regions and generally transparent regions of the strip.

It is also possible to arrange optically active elements which extend both over a generally metallised region and an adjacent generally transparent region, provided that the optically active element produces a desired optical effect.

1. A strip for safeguarding a document, comprising a support on which there is formed in the longitudinal direction of the strip an alternation of generally metallised regions and generally transparent regions, said alternation being capable of establishing a contrast on a scale identified as global at the level of the document to be safeguarded in such a way as to constitute protection against reproduction of the documents with which the strip will be associated, wherein the strip also comprises optically active elements in association with the generally metallised regions and/or the generally transparent regions of the strip to produce an optical effect on a scale identified as detail at the level of the document to be safeguarded, said optical effect making it possible to constitute a recognizable sign for identifying said document.

2. A document safeguard strip according to claim 1, wherein said optical effect established on said detail scale is a contrast.

3. A document safeguard strip according to claim 1, wherein said optical effect established on said detail scale is a visual effect dependent on the angles of illumination and/or observation of the strip.

4. A document safeguard strip according to claim 1, wherein said generally transparent regions of the strip are associated with a varnish producing a glossy effect visible to the naked eye.

5. A document safeguard strip according to claim 1, wherein said optically active elements comprise optically active structures formed from a metallization.

6. A document safeguard strip according to claim 1, wherein said optically active elements comprise optically variable elements.

7. A document safeguard strip according to claim 1, wherein at least some of said optically active structures comprise one or more of the following safeguard elements:
zone comprising diffraction lines,
purely reflective metallised zone,
zone comprising a diffraction mat,
zone comprising a hologram,
demetallised zone of a generally metallised region,
zone bearing printing, and
metallised zone of a generally transparent region.

8. A document safeguard strip according to claim 7, wherein at least some of said optically active structures comprise different zones of which some comprise at least one of said safeguard elements.

9. A document safeguard strip according to claim 8 wherein at least some of said zones are of a sufficiently small dimension as to not be immediately perceptible to the naked eye.

10. A document safeguard strip according to claim 1, wherein at least some of said optically active elements are associated with generally metallised regions.

11. A document safeguard strip according to claim 10, wherein said optically active elements comprise a diffraction mat integrated into a diffractive metallised region.

12. A document safeguard strip according to claim 10, wherein said optically active elements comprise purely reflective metallised regions.

13. A document safeguard strip according to claim 12, wherein said optically active elements comprise purely reflective metallised regions which, in the longitudinal direction of the strip, are disposed on respective sides of at least some of said generally metallised regions of the strip, said metallised regions being generally diffractive regions.

14. A document safeguard strip according to claim 13, wherein for each generally metallised and diffractive region, on respective sides of which are disposed purely reflective metallised regions, said purely reflective regions are disposed in immediately adjacent relationship with said generally metallised and diffractive region.

15. A document safeguard strip according to claim 13, wherein for each generally metallised and diffractive region, on respective sides of which are disposed purely reflective metallised regions, said purely reflective regions are disposed in such a way as to provide in the longitudinal direction of the strip an interval between said purely reflective region and said generally metallised and diffractive region.

16. A document safeguard strip according to claim 15, wherein said interval is transparent.

17. A document safeguard strip according to claim 1 wherein at least some of said optically active elements are associated with generally transparent regions.

18. A document safeguard strip according to claim 17, wherein said optically active elements comprise purely reflective metallised regions, and wherein said optically active elements comprise purely reflective metallised regions which, in the longitudinal direction of the strip, are disposed on respective sides of at least some of said generally transparent regions of the strip.

19. A document safeguard strip according to claim 18, wherein for each generally transparent region on respective sides of which are disposed purely reflective metallised regions, said purely reflective regions are disposed in immediately adjacent relationship with said generally transparent region.

20. A document safeguard strip according to claim 18, wherein for each generally transparent region on respective sides of which are disposed purely reflective metallised regions, said purely reflective regions are disposed in such a way as to provide in the longitudinal direction of the strip an interval between said purely reflective region and said generally transparent region.

21. A document safeguard strip according to claim 20, wherein said interval is:
an interval comprising metallised and diffractive zones, and/or
an interval comprising printed zones, and/or
an interval comprising a diffraction mat, and/or
an interval comprising a hologram.

22. A document safeguard strip according to claim 1, wherein said optically active elements are associated in register relationship with the generally metallised regions and/or the generally transparent regions of the strip.

23. A document safeguard strip according to claim 1, wherein the strip is also associated with luminescent or absorbent motifs.

24. A document safeguard strip according to claim 23, wherein said luminescent or absorbent motifs are printed in overlapping relationship with the strip.

25. A document safeguard strip according to claim 24, wherein said printing is effected in at least partially overlapping relationship with generally metallised regions of the strip.

26. A document safeguard strip according to claim 24, wherein said printing is effected in at least partially overlapping relationship with generally transparent regions of the strip.

27. A document safeguard strip according to claim 23, wherein said luminescent or absorbent motifs are integrated in the interior of the strip.

28. A security document incorporating a strip according to claim 1.
